(19) United States
(12) Patent Application Publication
(10) Pub. No.: US 2010/0043239 A1
(43) Pub. Date: Feb. 25, 2010

(54) Brownie/Cake Cutter

(76) Inventor: William Lee Pittman, Berkeley Springs, WV (US)

Correspondence Address: William Lee Pittman, 2178 Martinsburg Road, Berkeley Springs, WV, 25411, US

(21) Appl. No.: 12/460,290

(22) Filed: Jul. 16, 2009

Related U.S. Application Data
(60) Provisional application No. 61/082,871, filed on Jul. 23, 2008.

(51) Int. Cl. B26B 3/00

(52) U.S. Cl. 30/305

(57) ABSTRACT

A food product cutting device that is used to cut baked products in foodservice or bakery sheet pans. This apparatus is assembled by using a series of intersecting blades that attach to a holding frame. These intersecting blades create square, rectangle or triangle compartments. Inside each of these compartments are spring assisted stripper pads that attached to a top plate that is attached to the top side of the frame. These pads slide up and down inside the compartments to release the cut product pieces as the cutting cycle is completed. This cutting head is design to be installed on a table top frame or mounted on a conveyor for automated use by the end user. This invention decreases cutting time and increases production output as well as reducing fatigue and injuries associated with repetitive motion action.

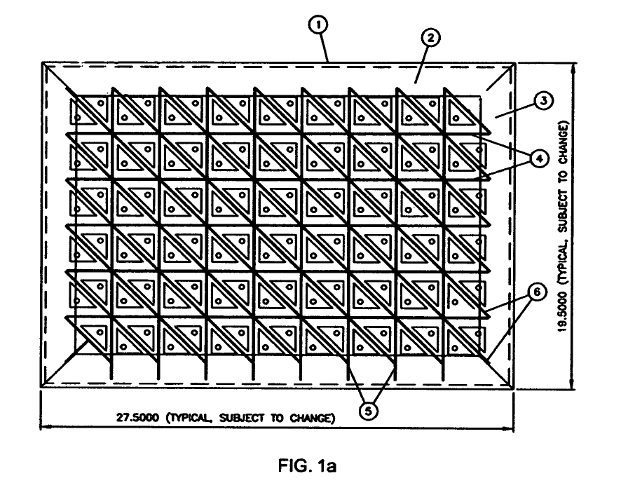

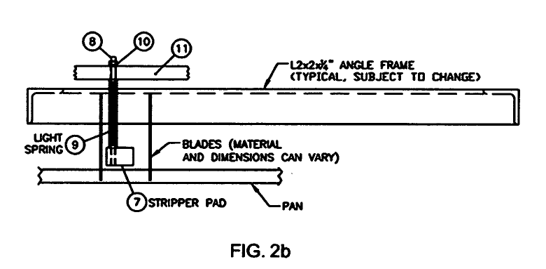

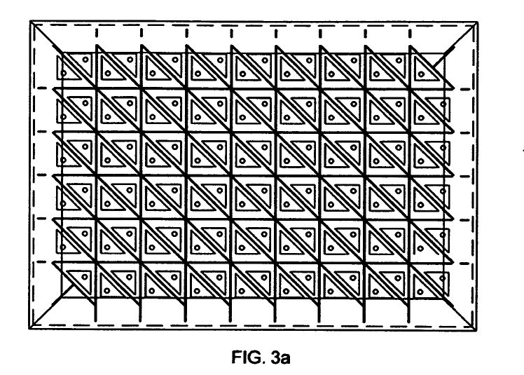

The present invention relates to a brownie/cake cutter. The cutter head frame (item 1 FIG. 1a) is made of stainless steel or aluminum angle material measuring 2″×2″×0.25″ for the full sheet pan size. This is done by cutting 2 pieces measuring 19.5″ long (item 3 FIG. 1a) and 2 pieces 27.5″ long (item 2 FIG. 1a) with 45 degree angles on each end. These are welded together to create a frame in which the cutting blades and stripper pad assemblies are attached.

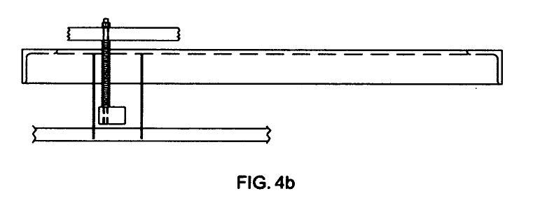

Cutting blades are made from stainless steel sheet metal in 16 or 20 gauge thickness. This thickness can vary according to the density and ingredients of the product being cut. These blades measure 5″×26.5″ for the long blades (item 4 FIG. 1a) and 5″×18.5″ for the short blades (item 5 FIG. 1a). All of these blades have angled ends at 45 degrees that make the bottom cutting length 16.5″ for the short blade and 24.5″ for the long blade. A cutting edge is ground on the short side of each blade to create a cutting edge thickness of approximately 0.005″. These blades will have notches cut in the top of one set and the bottom of the other set with an opening slightly wider than the thickness of the blade to allow them to intersect together creating a grid pattern of either squares, rectangles or triangles. Triangle grids require a third set of diagonal blades (item 6 FIG. 1a) with varying lengths as depicted in the drawings.

The blade assembly is then placed and centered inside the head frame. The blades that have the intersecting slots machined in the bottom are “tack” welded to the frame. This allows the other blades to be held in position without welding. This is considered the standard attachment method.

Stripper pads (item 7 FIG. 2b) made of a food grade material to fit inside of these grid compartments. These pads are 0.75″ thick and 0.010+/− smaller than the inside of each grid. This will allow the stripper pad to move up and down inside the grid. A threaded hole with a thread size of ¼″×20 is located near the center and drilled 0.625″ deep. Threaded rods (item 8 FIG. 2b) ¼″×20 are cut approximately 6.75″ long and inserted into these holes. These stripper pads are used in the cutting head assembly to remove the cut pieces from the grid, later described.

A top plate (item 11 FIG. 2b) is made of a food grade plastic composite sheet measuring 0.75″ thick. The dimensions are 19.5″×27.5″ for the full sheet pan cutter. Holes 5/16″ in diameter are drilled in a pattern to match the centers of each grid pattern made by the intersecting blades which have been attached to the head frame. This plate is then attached to the top side of the cutter frame using threaded fasteners. The number of fasteners can vary but would typically be six, 5/16″×18 thread, one in each corner and one in the center of each long dimension of the frame and plate.

Now the stripper pad assembly can be completed by installing a compression spring (item 9 FIG. 2b) varying in length up to 5″ onto the threaded rods. The stripper pads (item 7 FIG. 2b) can now be inserted into the grids with the top end of the rods (item 8 FIG. 2b) going into and through each hole in the top plate (item 11 FIG. 2b). The top of the spring will make contact with the bottom of the top plate. The rod (item 8 FIG. 2b) is held in place with a nylon lock fastener (item 10 FIG. 2b). This system allows the stripper pads (item 7 FIG. 2b) to move up while the springs (item 9 FIG. 2b) push them back down with a small amount of force.

Now the completed cutting head assembly can be installed on a framework by the inventor or others. The end user can elect to use various methods to cut his product. The head can be installed into a frame using pneumatic or hydraulic cylinders. The cutting head can be stationary and move the product up/down with a lift table attached to the cylinders. Or make the product table stationary and move the cutting head down/up.

The cutting method is unique. As the product is cut the top of the product makes contact with the stripper pads. The pads move up compressing the spring until the cut cycle is completed. As the product is retracted from the blades the springs gently push the cut pieces out from the compartments keeping them in the pan or on a cutting surface. This cutting system assures clean cuts with uniform sizes and shapes while increasing productivity and decreasing injuries associated with repetitive movements, cutting by hand.

This substitute specification does not contain any new matter.

What is claimed:

1. A device to cut cake or like product baked in a sheet pan using a series of blades meshing together to create square, rectangle, diamond or triangular shape pieces in the pan. Rows or strips can also be created in the length and width of the pan. No depanning is necessary before cutting. Cut product is kept in the pan after cutting by using a series of spring loaded stripper pads located inside each cutting compartment to push the product pieces out from the compartments. This device can be installed on a frame by the end user and operated by one or more pneumatic or hydraulic cylinders. The product, either in or out of the pan is inserted onto a table under the cutting head. The operator can press and/or hold switching devices which causes the table to rise or the cutting head to lower via the cylinders. The product is pushed into the cutting head. As the product is being cut, spring loaded stripper pads inside each cutting compartment moves up. When the cutting motion stops the switches are released allowing the product to retract from the blades. The cut pieces are gently pushed out from the blade assembly and kept in the pan or on the table surface by the spring loaded stripper pads.
